(19) United States
(12) Patent Application Publication
(10) Pub. No.: US 2002/0121546 A1
(43) Pub. Date: Sep. 5, 2002

(54) Smart e-card

(76) Inventor: Joseph S. Clark, Nampa, ID (US)

Correspondence Address: HEWLETT-PACKARD COMPANY, Intellectual Property Administration, P.O. Box 272400, Fort Collins, CO, 80527-2400, US

(21) Appl. No.: 09/797,879

(22) Filed: Mar. 5, 2001

(51) Int. Cl. G06K 15/00

(52) U.S. Cl. 235/383

(57) ABSTRACT

The use of smart e-card to transmit transaction data from POS to the customer's home computer may alleviate customers of the tedious tasks of keeping accurate records of what is bought, filling out complex rebate forms, mailing out warranty card on time to preserve warranty benefits, or checking expiration dates and/or instructions on how to operate the products. Accordingly, the use of smart e-card may help customers to be better informed, take better advantage of rebates and warranty benefits, stay abreast of expiration dates, and cause fewer accidents by not following usage directions. In addition, the use of smart e-card may collect information about the customer for use by the store where products were purchased. Manufacturers may also use the customer's purchasing data to learn the his/her spending habits and preferences.

### BACKGROUND

1. Field of the Invention

The present invention relates to communication of data via the Internet, and, in particular, to the use of smart e-card for transmission of data from point of sale (POS) to a personal computer via the Internet.

2. Description of Related Art

After a shopping trip from a retail facility, a typical consumer may find himself faced with extraneous tasks, such as keeping accurate records of what is bought, filling out complex rebate forms, mailing out warranty cards on time to preserve warranty benefits, and checking expiration dates and/or instructions on how to operate the products. These tasks may be tedious and time-consuming, and are normally omitted by busy consumers leading to loss of valuable rebate or warranty benefits, consumption of expired products, or improper usage of products.

One approach, U.S. Pat. No. 6,185,542 B1 (Moran, et. al.), discloses a method for transmitting, via e-mail, by a store computer controlling apoint of sale (POS) terminal, transaction data to a personal computer of a customer making the transaction. The transaction data includes the actual items purchased with price and the grocery code of each item, and the transaction data is transmitted as an e-mail message via the Internet. According to Moran, et. al., the communication address of the customer computer is identified to the store computer by a store card that is utilized for other purposes or through the use of a standard credit card. In either case, the customer must have first submitted the e-mail address to the store or credit card company.

However, for customers who do not have store cards, or have not submitted e-mail addresses to the credit card companies, the option is not available to them to accurately capture and store the transaction data. In addition, Moran, et. al. merely provide the customer a list of products purchased. It does not solve the problem of tedious tasks of filling out rebate slips, warranty cards, or checking expiration dates and usage instructions.

### SUMMARY

The use of a smart e-card to transmit transaction data from point of sale (POS) to the customer's home computer may alleviate customers of the tedious tasks of keeping accurate records of what is bought, filling out complex rebate forms, mailing out warranty card on time to preserve warranty benefits, or checking expiration dates and/or instructions on how to operate the products. The use of smart e-card may help customers to be better informed, take better advantage of rebates and warranty benefits, stay abreast of expiration dates, and cause fewer accidents by not following usage directions. In addition, the use of smart e-card may collect information about the customer for use by the store where products were purchased. Manufacturers also may use the customer's purchasing data to learn his/her spending habits and preferences for marketing purposes.

### BRIEF DESCRIPTION OF THE DRAWINGS

The preferred embodiments of the present invention will be described in detail with reference to the following figures, in which like numerals refer to like elements, and wherein:

FIG. 1 is a flow chart of one exemplary embodiment of the present invention;

FIG. 2 is a flow chart of another exemplary embodiment of the present invention; and

FIG. 3 is a block diagram illustrating exemplary hardware components of a computer that is used to implement the present invention.

### DESCRIPTION OF PREFERRED EMBODIMENTS

A smart e-card is a credit card like device with a built-in microprocessor and memory used for identification or financial transactions. When inserted into a reader, it transfers data to and from a central computer. It is more secure than a magnetic stripe card and can be programmed to self-destruct if the wrong password is entered too many times.

The use of a smart e-card to transmit transaction data from a point of sale (POS) to a customer's home computer may help the customer to be better informed, take better advantage of rebates and warranty benefits, stay abreast of expiration dates, and cause fewer accidents by not following usage directions. In addition, the use of a smart e-card may collect information about the customer for use by the store where products were purchased. Manufacturers may also use the customer's purchasing data to learn the his/her spending habits and preferences.

In a typical shopping transaction, after the customer selects products for purchasing, a cashier may scan the bar code, i.e., UPC code, for each product selected. The UPC code for each product, together with other associated data, may contain pertinent information, such as expiration date, warning labels, directions for use, rebates available, customer support, warranties, specifications of the product, or any other information about the product.

The UPC code for each product purchased may be saved in the cash register's memory until all purchases are scanned and paid for. Then, the customer may give his/her smart e-card to the cashier, who may insert the card into a scan slot on the cash register. The smart e-card may contain information about the customer, such as name, address, phone number, and e-mail address. The scan slot on the cash register may be similar to a credit card or debit card scan slot. The cash register may read the customer information and save it to the register's memory.

In one exemplary embodiment of the present invention, with the push of a button on the cash register, all of the information from the scanned UPC codes may be compressed into an e-mail message that may be sent to the customer's e-mail address to be retrieved later from his/her home computer.

In another exemplary embodiment of the present invention, the cash register may save the information from the scanned UPC codes to the smart e-card to be retrieved by the customer later. In this embodiment, the customer may insert the smart e-card into his/her home computer's input/output device, such as a bar code reader, which downloads the information onto the computer's memory and secondary storage.

After the information is stored in the customer's home computer, the customer may, at his/her leisure, retrieve and read the product information, such as expiration dates, warning labels, directions for use, rebates available, customer support, warranties, specifications of the product, or any other information about the product. Because of the convenience in accessing the product information, the customer may be more likely to read the expiration dates, warning labels, and directions for use, thus less likely to consume expired products, or cause accidents by not following usage directions.

The customer may have an option to send rebate forms and warranty forms on-line to the manufacture, taking advantage of the network services. After the customer retrieves the product information from the home computer, the rebate forms and warranty forms may automatically appear on the screen to be filled out. By simply checking a few boxes, the customer may send the forms back to the manufacturer. Because of the convenience in processing the forms, the customer may be more likely to take advantage of rebates and warranty benefits.

In addition to providing customers with valuable information, the use of smart e-card may collect information about the customer for use by the store where products were purchased. The store may also send the customer's purchasing data to the manufacturers, so that the manufacturers may learn the customer's spending habits and preferences for marketing purposes.

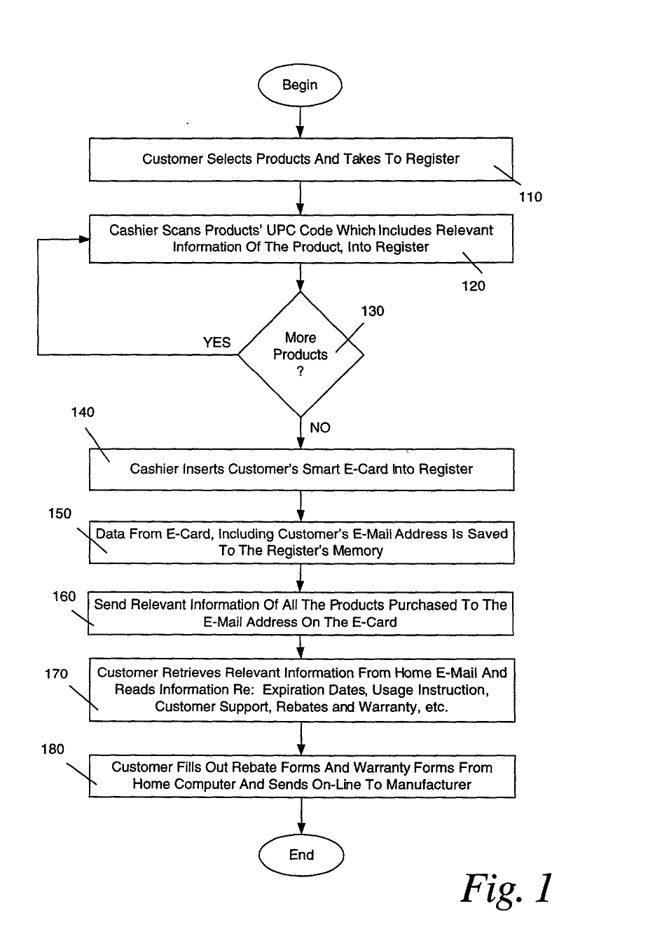

FIG. 1 illustrates one embodiment of the present invention. After the customer selects products and takes them to the register computer, step 110, the cashier scans the products' bar code, i.e., UPC codes, into the register, step 120. The UPC codes include the relevant information of the products, such as expiration dates, warning labels, directions for use, rebates available, customer support, warranties, specifications of the product, or any other information about the product. After all products have been scanned and paid, the cashier inserts the customer's smart e-card into the register, step 140. The data from the smart e-card, including the customer's e-mail address, is saved to the register computer's memory, step 150. The smart e-card also includes the customer's name, phone number, and address to be collected by the store. Next, the register computer sends the relevant information of all the products purchased to the e-mail address on the smart e-card for future retrieval, step 160.

When the customer goes home, he/she conveniently retrieves and reads the relevant information of all the products purchased from home e-mail, step 170. The customer also fills out rebate forms and warranty forms from his/her home computer and sends them to the manufacturers via on-line means to be processed and recorded, saving the customer time and hassle in processing the various forms by mail, step 180. The store may send the customer's purchasing data to the manufacturers, so that the manufacturers can use the customer's purchasing data for marketing purposes.

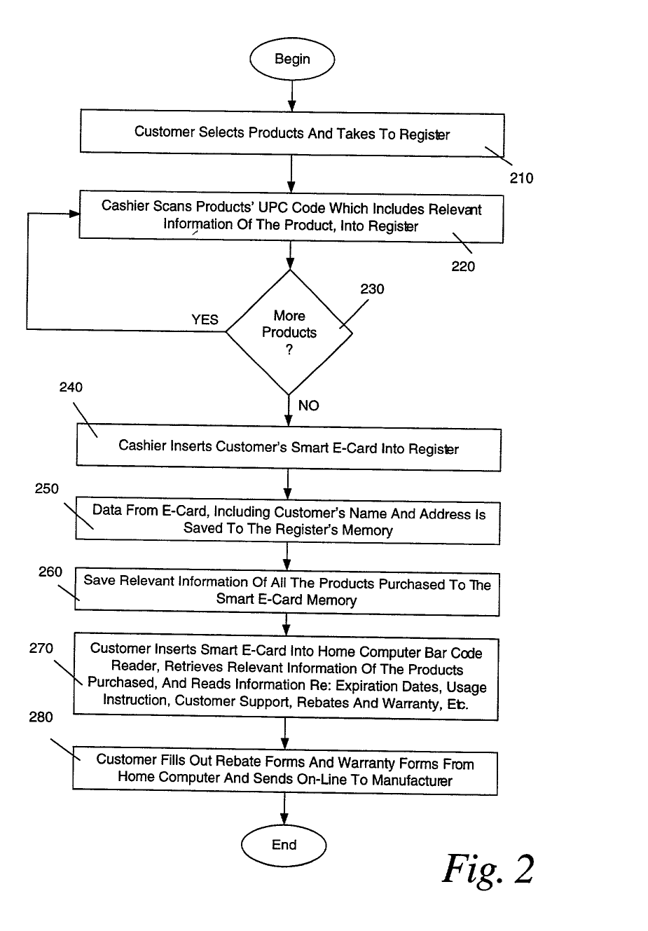

FIG. 2 illustrates another embodiment of the present invention. The customer selects products at the store, and takes the products to the register, step 210. The cashier scans all of the products' bar codes, i.e., UPC codes, which include the relevant information of the products, into the register computer, step 220. After all the products are scanned and paid, the cashier inserts the customer's smart e-card into the register, step 240. The data from the smart e-card, which includes the customer's name, phone number, and address, is saved to the register computer's memory for store collection, step 250. At the same time, the relevant information of all the products purchased is saved to the smart card's memory, step 260.

After the customer finishes shopping and goes home, he/she inserts the smart e-card into his/her home computer's input/output device, such as a bar code reader, which downloads the relevant information of the products purchased onto the home computer's memory, step 270. The customer then, at his/her leisure, retrieves and reads the relevant information of the products purchased, which includes expiration dates, warning labels, directions for use, rebates available, customer support, warranties, specifications of the product, or any other information about the product, step 270. The customer also fills out rebate forms and warranty forms from his/her home computer and sends them to the manufacturers via on-line means to be processed and recorded, step 280.

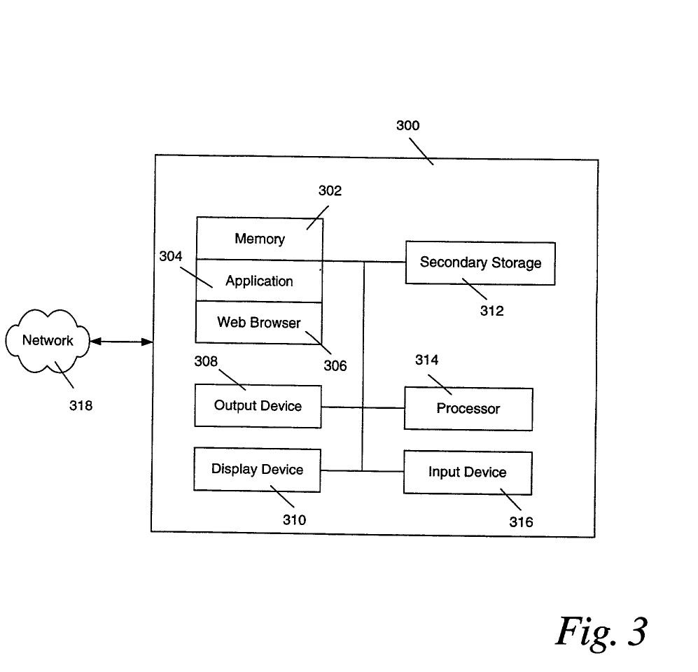

FIG. 3 illustrates exemplary hardware components of a computer 300 that is used to implement the present invention. The computer 300 includes a connection with a network 318 such as the Internet or other type of computer or phone networks. The computer 300 typically includes a memory 302, a secondary storage device 312, a processor 314, an input device 316, a display device 310, and an output device 308.

The memory 302 includes random access memory (RAM) or similar types of memory. The memory 302 stores one or more applications 304 for execution by the processor 314. The applications 304 may correspond with software modules to perform processing for the method described below. The memory 302 is connected to the network 318 by a web browser 306. The web browser 306 makes a connection via the WWW to other computers known as web servers, and receives information from the web servers that is displayed on the computer 300. The secondary storage device 312 preferably includes a hard disk drive, floppy disk drive, CD-ROM drive, or other types of non-volatile data storage, and it corresponds with various databases or other resources. The processor 314 executes applications 304 or other information stored in the memory 302, the secondary storage 312, or received from the Internet or other network 318. The input device 316 includes any device for entering data into the computer 300, such as a keyboard, keypad, cursor-control device, touch-screen (possibly with a stylus), or microphone. The display device 310 includes any type of device for presenting visual image, such as, for example, a computer monitor, flat-screen display, or display panel. The output device 308 includes any type of device for presenting data in hard copy format, such as a printer, and other types of output devices including speakers or any device for providing data in audio form. The computer 300 may include multiple input devices, output devices, and display devices.

Although the computer 300 is depicted with various components, one skilled in the art will appreciated that this computer can contain additional or different components. In addition, although aspects of an implementation consistent with the present invention are described as being stored in memory, one skilled in the art will appreciated that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 300 to perform a particular method.

While the present invention has been described in connection with an exemplary embodiment, it will be understood that many modifications in light of these teachings will be readily apparent to those skilled in the art, and this application is intended to cover any variations thereof.

What is claimed is:

1. A method for transmitting product information from a point of sale (POS) register to a customer computer, comprising steps of:
scanning bar codes to collect product information in a register;
inserting a smart e-card into the register;
saving customer information from the smart e-card to the register's memory, wherein the customer information includes at least one of a customer's name, an address, a phone number, and an internet address;
sending the product information to the internet address via a network to a customer computer; and
retrieving the product information from the customer computer at the internet address.

2. The method of claim 1, wherein the scanning step includes scanning at least one of a products' expiration date, a warning label, a direction for use, a rebate availability, a customer support information, a warranty, a specification of a product, and any other product specific information.

3. The method of claim 1, further comprising a step of sending one of a rebate form and a warranty form to a manufacturer via the network.

4. The method of claim 3, wherein the step of sending one of the rebate form and the warranty form includes sending the form via the Internet.

5. The method of claim 1, wherein the saving step includes saving the internet address to a memory of the register.

6. The method of claim 1, wherein the sending step includes sending the product information via the Internet.

7. The method of claim 1, further comprising a step of printing the product information from the customer computer.

8. The method of claim 1, further comprising a step of sending customer purchasing data to a manufacturer.

9. A method for transmitting product information from a point of sale (POS) register to a customer computer, comprising steps of:
scanning bar codes to collect product information in a register;
inserting a smart e-card into the register;
saving customer information from the smart e-card to the register's memory, wherein the customer information includes at least one of a customer's name, an address, a phone number, and an internet address;
saving the product information to the smart e-card; and
retrieving the product information from the customer computer.

10. The method of claim 9, wherein the scanning step includes scanning at least one of a products' expiration date, a warning label, a direction for use, a rebate availability, a customer support information, a warranty, a specification of a product, and any other product specific information.

11. The method of claim 9, further comprising a step of sending one of a rebate form and a warranty form to a manufacturer via the network.

12. The method of claim 11, wherein the step of sending one of the rebate form and the warranty form includes sending the form via the Internet.

13. The method of claim 9, further comprising a step of printing the product information from the customer computer.

14. The method of claim 9, further comprising a step of sending customer purchasing data to a manufacturer.

15. A system comprising:
a register capable of scanning bar codes to extract product information;
a smart e-card capable of storing at least one of a customer's name, an address, a phone number, and an internet address, wherein the register is capable of receiving and saving information from the smart e-card in a memory;
a network capable of transmitting the product information from the register to the internet address; and
a computer at the internet address capable of retrieving the product information.

16. The apparatus of claim 15, wherein the product information includes at least one of a product's expiration date, a warning label, a direction for use, a rebate availability, a customer support information, a warranty, a specification of a product

17. The apparatus of claim 15, wherein the network is the Internet.

18. The apparatus of claim 15, wherein the internet address includes a customer's e-mail address.

19. The apparatus of claim 15, further comprising a printer capable of printing the product information from the computer.

20. The apparatus of claim 15, wherein the register is capable of sending a customer's purchasing data to a manufacturer.
